(19) United States
(12) Patent Application Publication
(10) Pub. No.: US 2008/0229938 A1
(43) Pub. Date: Sep. 25, 2008

(54) Toddler Food Slicer

(76) Inventor: Kathy Hutto, LaGrange, GA (US)

Correspondence Address: Steven L. Schmid, 1824 Hickory Trace Dr., Fleming Island, FL, 32003, US

(21) Appl. No.: 12/016,444

(22) Filed: Jan. 18, 2008

Related U.S. Application Data
(60) Provisional application No. 60/881,054, filed on Jan. 19, 2007.

(51) Int. Cl. A47J 43/04; B26D 1/03; B26D 1/00

(52) U.S. Cl. 99/537; 83/858; 83/13

(57) ABSTRACT

Disclosed is both an apparatus and method for slicing a toddler's food into small bite sized portions for reducing the chance of choking and increasing a toddler's ease of eating the food. The food slicer includes a frame which fits around the food to be reduced and cutting blades fitted within the frame. The food is reduced into small bite sized portions by pressing the food slicer into the food and then removed. The blades of the food slicer can cut the food into bite sized cubes or slices depending upon the configuration of the blades with the frame.

### RELATED APPLICATION

This application relies upon U.S. Provisional Application Ser. No. 60/881,054 filed Jan. 19, 2007, the content of which is hereby incorporated in its entirety.

### Technical Field

The present invention relates to an apparatus and method for slicing food. In greater detail, the present invention relates to a method and apparatus for cutting food into bite sized portions for a toddler to aid in the prevention of choking and in the consumption of the food by the toddler.

### BACKGROUND

Starting from ages one to two, a child should get about 70 percent of his calories from solid foods. To guard against choking, a toddler's food should be cut into small pieces. Children have a smaller diameter esophagus than adults, and consequently they choke on their food more often. Furthermore, many kids do not chew their food enough so it's best to cut their food into pieces small enough to pass through their esophagus. Thus, about 75% of all choking injuries occur in children under the age of four years old.

Young children typically do not grind or chew their food well and they may attempt to swallow the food whole. Thus, most doctors recommend that food fed to young children such as toddlers be cut or chopped to reduce the bite size, and consumed under adult supervision.

While typically the obstruction is cleared and the child is not harmed in a choking incident, choking nevertheless is a frightening experience for kids and their adult care givers. Choking is especially dangerous at schools and other places with a high child-to-adult ratio because children are generally not as informed and able to recognize that another person is choking and to physically dislodge the obstruction.

The most common method of reducing the portion of a toddler's food is by using a knife to manually cut the food into small bite sized portions. Unfortunately, this method is both time consuming and tedious. Such labor intensive methods are often impractical for the busy parent or day care worker who must balance the needs of many children and activities.

Thus, what is needed is a method and apparatus for reducing the portion of food fed to toddlers that is quick and simple while providing a safe portion for the child to prevent chocking.

### SUMMARY

The present invention includes both an apparatus and method for slicing a toddler's food into small bite sized portions for reducing the chance choking by the toddler on his or her food. The present food slicer includes a frame which fits around and encloses the perimeter of the food to be reduced. The device further includes cutting blades fitted within the frame. The food is reduced into small bite sized portions by pressing the food slicer into the food and then removed. The blades of the food slicer can cut the food into bite sized cubes or slices depending upon the configuration of the blades with the frame.

In greater detail the present food slicer for reducing a food into bite sized portions for a toddler comprises a peripheral frame having opposed inner walls and outer walls The peripheral frame is sized to encompass the outer perimeter of the food to be reduced to bite sized portions. Additionally, a plurality of cutting blades are fitted within and attached to the peripheral frame, wherein the blades extend from a first inner wall to a second opposed inner wall for slicing the food encompassed by the frame. The cutting blades are spaced parallel to each other. The spacing may be equal or varied. The cutting blades may run perpendicular to each other within the frame to form a rectangular square cutting pattern within the frame for cubing the food into bite sized portions.

In a further embodiment a first cutting blade bisects the peripheral frame at the frame's greatest length and a plurality of parallel blades fitted within the frame running perpendicular to the first cutting blade. This configuration is especially advantageous in reducing a hot dog since it is important to bisect the hog dog along its length along with cutting it up into smaller bite sized lengths.

Additionally, a plurality of cutting blades may be fitted within the peripheral frame parallel to each other for cutting a food about only the horizontal axis of the food. This configuration is helpful in reducing bananas and the like.

An additional embodiment includes a food slicer having a plurality of cutting blades fitted within and attached to the peripheral frame, wherein the blades extend from a first inner wall to a second opposed inner wall for slicing a food encompassed by the frame. The cutting blades include a first set of blades running parallel to each other and perpendicular to the first and second opposed inner walls. The cutting blades further include a second set of cutting blades running parallel to each other and perpendicular to the first set of blades and perpendicular to a third and forth opposed inner walls of the peripheral frame. This configuration forms rectangular cutting squares within the cutter for cubing the food into bite sized portions.

A further embodiment includes a method of preparing a food for a toddler into bite sized portions. The method includes the steps of providing a food for reducing into bite sized portions and then placing over and pressing into the food, a food slicer. The food slicer includes the peripheral frame having blades fitted within for cutting the food. The food slicer is then removed from the food to reveal the food reduced into bite sized potions.

### DRAWINGS

In the drawings:

FIG. 1 is an overhead view of an embodiment of the present invention showing the peripheral frame and the plurality of cutting blades;

FIG. 2 is a further view of the same noting the intersection cutting blades forming rectangular boxes within the frame for cubing a food into smaller portions;

FIG. 3 is an additional view of the same showing an angled view;

FIG. 4 is a further embodiment illustrating a center cutting blade bisecting the frame and having cutting blades running perpendicular to it, this embodiment is especially useful in reducing a hot dog; and

FIG. 5 is an additional embodiment wherein the frame is shaped similar to the food to be cut, in this case a banana, wherein blades run perpendicular to the longitudinal axis of the frame.

### DETAILED DESCRIPTION

Disclosed is both an apparatus and method for slicing a toddler's food into small bite sized portions. The smaller bite sized portions reduce the chance the child may choke on the food. The disclosed food slicer includes a frame sized to fit around the food to be reduced. The frame includes a plurality of cutting blades fitted within for slicing the food. The reduction of the food is accomplished by pressing the food slicer into the food and then removing it. The reduced food portions can take on most any configuration depending upon the configuration of the blades with the frame.

Within the present application the term “toddler” is used to refer to any child who needs their food reduced to aid in preventing the occurrence of choking. In an additional embodiment the term “toddler” may refer to any person who needs such service. The term “reduced” is used herein to refer to the cutting of the food into smaller portions that may be consumed by a toddler at a reduced risk of chocking. The term “cubed” is used to mean the cutting of portions that may resemble a cube or a portion thereof but is not meant to mean a formal cube but may include any irregular shape. The term “rectangular box” includes both square boxes and rectangular boxes. The term may also include other shapes defining the bite sized portion formed, including triangles which are not illustrated in the present drawings.

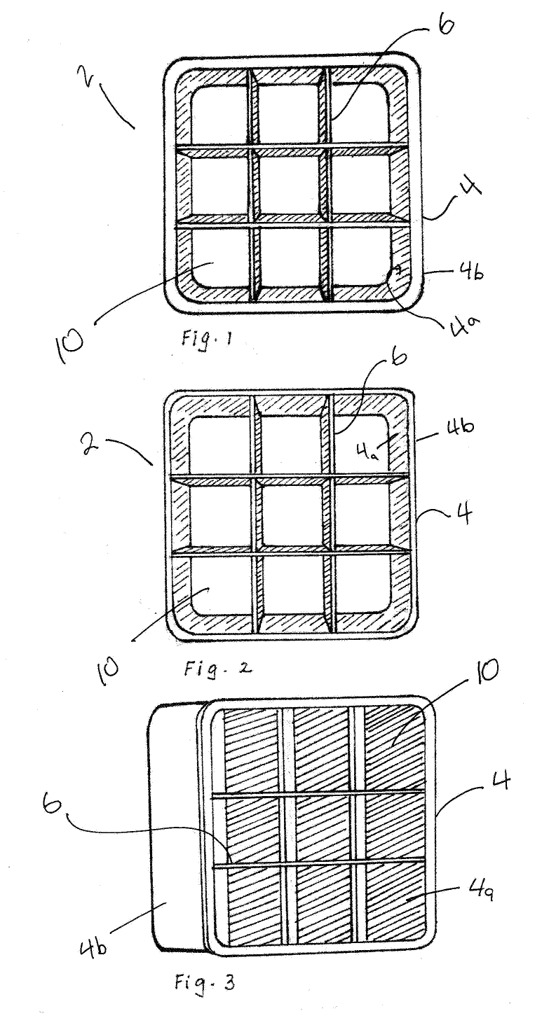

Referring now in greater detail to the drawings in which like numerals indicate like items throughout the several views, FIGS. 1-5 depict the present apparatus and method of for slicing a toddler's food into small bite sized portions in the various embodiments of the present invention.

FIGS. 1-3 depict an embodiment the present food slicer 2 for reducing a food into bite sized portions for a toddler including a peripheral frame 4 having opposed inner walls 4a and outer walls 4b. The peripheral frame 4 is sized to encompass the outer perimeter of a food to be reduced to bite sized portions. Additionally, a plurality of cutting blades 6 are fitted within and attached to the peripheral frame 4, wherein the blades 6 extend from a first inner wall 4a to a second opposed inner wall 4a for slicing the food encompassed by the frame 4. The cutting blades 6 in this embodiment are spaced parallel to equal to each other. Of course, the spacing may also be varied. The cutting blades 6 in this embodiment run perpendicular to each other within the frame to form a rectangular cutting surface within the frame for cubing the food into bite sized portions.

In greater detail, the dimensions of the frame 4 may be from about two to six inches by about two to six inches and in a further embodiment four inches by four inches. The number of rectangular boxes 10 formed by the intersection cutting blades 6 within the frame 4 may be between six to twelve boxes 10 and in an additional embodiment the frame 4 includes nine boxes 10.

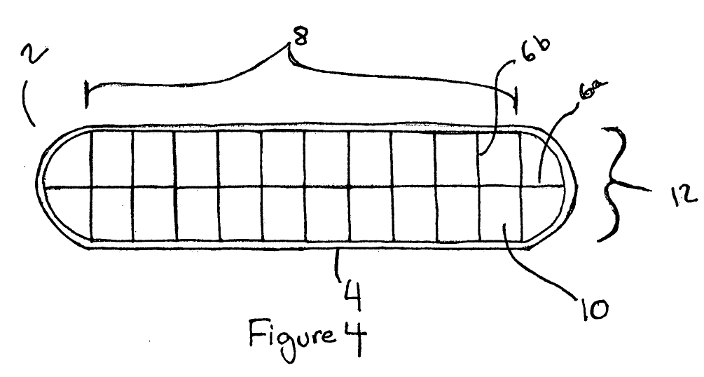

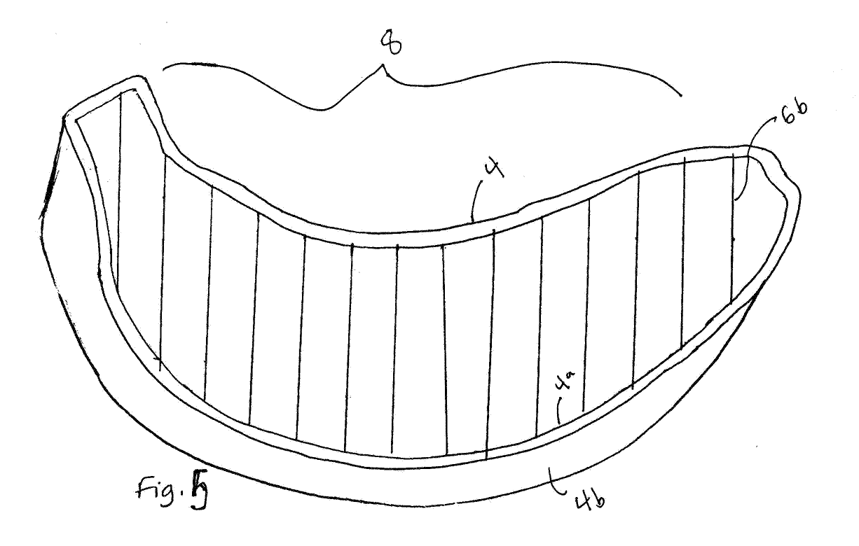

FIG. 4 illustrates a further embodiment useful in cutting a hot dog. However, it is contemplated that the embodiment may be used for other foods. As illustrated, a first cutting blade 6a bisects the peripheral frame 4 at the frame's longitudinal axis 8 or greatest length. This embodiment further includes a plurality of cutting blades running parallel 6b to each other and perpendicular to the first cutting blade.

In the embodiment illustrated in FIG. 4, example dimensions include the longitudinal axis 8 of the frame 4 between about three to seven inches and in a further embodiment about 5 inches. The width 10 of the frame is between about one to two inches and in an additional embodiment about 1.25 inches. The rectangular boxes formed by the intersecting cutting blades 6 the may have a width of about 0.5 inches.

FIG. 5 depicts an additional embodiment of the present cutter useful in reducing bananas and the like. Depicted is a plurality of cutting blades 6b fitted within the peripheral frame 4 running parallel to each other and perpendicular to the longitudinal axis 8 of the frame 4 for cutting a food about the horizontal axis of the food.

The components of the present invention are generally made from plastic, metal, or other suitably rigid materials. The parts therefore may be molded or stamped, or by other methods known in the art. For example, the frame may be molded if made from plastic, or die cast if made from metal. The blades may be molded if plastic and then sharpened by grinding, for example. Or, the blades may be stamped and sharpened if necessary when made from metal. If made from metal wire, the blades may simply be extruded to form wire in fine to course diameters, 1/128 to 1/16 inch diameters for example only, depending on design requirements. Additionally, the slicer may be formed from an integral body including both frame and blades of plastic or metal as described above.

While specific embodiments have been described in detail in the foregoing detailed description and illustrated in the accompanying drawings, those with ordinary skill in the art will appreciate that various modifications and alternatives to those details could be developed in light of the overall teachings of the disclosure. For example, the number of blades may be increased or decreased to alter the size and number of cut portions of the product being sliced. Accordingly, the particular arrangements disclosed are meant to be illustrative only and not limiting as to the scope of the invention, which is to be given the full breadth of any claims that are derivable from the description herein, and any and all equivalents thereof.

What is claimed is:

1. A food slicer for reducing a food into bite sized portions for a toddler comprising:
a peripheral frame having opposed inner walls and outer walls, wherein the peripheral frame is sized to encompass the outer perimeter of a food to be reduced to bite sized portions; and
a plurality of cutting blades fitted within and attached to the peripheral frame, wherein the blades extend from a first inner wall to a second opposed inner wall for slicing the food encompassed by the frame.

2. The food slicer for reducing a food of claim 1, further including the plurality of cutting blades spaced parallel to each other.

3. The food slicer for reducing a food of claim 2, wherein the plurality of cutting blades further run perpendicular to each other within the frame such that the cutting blades form a plurality of substantially rectangular cutting boxes whereby the food may be cubed into bite sized portions.

4. The food slicer for reducing a food of claim 2, wherein the spaced cutting blades are substantially equally spaced apart within the peripheral frame.

5. The food slicer for reducing a food of claim 1, wherein a first cutting blade bisects the peripheral frame at the frames greatest length and a plurality of blades running parallel to each other and perpendicular to the first cutting blade.

6. The food slicer for reducing a food of claim 1, wherein the plurality of cutting blades are fitted within the peripheral frame parallel to each other and perpendicular to the longitudinal axis of the frame for cutting a food about the horizontal axis of the food.

7. The food slicer for reducing a food of claim 1, wherein the frame and blade assembly are formed from an integral body.

8. The food slicer of claim 1, wherein the peripheral frame is sized to encompass the outer perimeter of a food selected from the group consisting essentially of a hotdog, sandwich, desert cake, pizza, banana and combinations thereof.

9. A food slicer for reducing a food into bite sized portions for a toddler comprising:
a peripheral frame having opposed inner walls and outer walls, wherein the peripheral frame is sized to encompass the outer perimeter of a food to be reduced to bite sized portions;
a plurality of cutting blades fitted within and attached to the peripheral frame, wherein the blades extend from a first inner wall to a second opposed inner wall for slicing the food encompassed by the frame; and
wherein the cutting blades include a first set of blades running parallel to each other and perpendicular to the first and second opposed inner walls and second set of cutting blades running parallel to each other and perpendicular to the first set of blades and perpendicular to a third and forth opposed inner walls of the peripheral frame to which the respective ends of the second set of blades are attached and extend from, whereby the food may be cubed into bite sized portions.

10. The food slicer for reducing a food of claim 9, wherein the spaced cutting blades are substantially equally spaced apart within the peripheral frame.

11. The food slicer of claim 9, wherein the peripheral frame is sized to encompass the outer perimeter of a food selected from the group consisting essentially of a hotdog, sandwich, desert cake, pizza, banana and combinations thereof.

12. The food slicer of claim 9, wherein the peripheral frame is substantially square.

13. The food slicer of claim 9, wherein the peripheral frame has the dimension of four inches by four inches with the intersecting and perpendicular cutting blades forming at least nine substantially square smaller sections for cubing the food.

14. A method of preparing a food for a toddler into bite sized portions comprising the steps of:
providing a food for reducing into bite sized portions;
placing over and pressing into the food a food slicer comprising a peripheral frame having opposed inner walls and outer walls, wherein the peripheral frame is sized to encompass the outer perimeter of the food to be reduced to bite sized portions and a plurality of cutting blades fitted within and attached to the peripheral frame, wherein the blades extend from a first inner wall to a second opposed inner wall for slicing the food encompassed by the frame; and
removing the food slicer from the food to reveal the food reduced into bite sized potions.

15. The method of claim 14, further including cubing the food into bite sized portions.

16. The method of claim 15, wherein the food is cubed by placing over and pressing into the food the food slicer, wherein the blades of the food slicer include a first set of blades running parallel to each other and perpendicular to the first and second opposed inner walls and second set of cutting blades running parallel to each other and perpendicular to the first set of blades and perpendicular to a third and forth opposed inner walls of the peripheral frame to which the respective ends of the second set of blades are attached and extend from, whereby the food may be cubed into bite sized portions.

17. The method of claim 14, wherein the food is sliced about the horizontal axis of the food.

18. The method of claim 17, wherein the food is sliced about the horizontal axis of the food by pressing into the food the food slicer, wherein the plurality of cutting blades are fitted within the peripheral frame parallel to each other for cutting a food about the horizontal axis of the food.
